(19) United States
(12) Patent Application Publication
(10) Pub. No.: US 2019/0004196 A1
(43) Pub. Date: Jan. 3, 2019

(54) Swellable Spacer Seismic Streamer

(71) Applicant: WESTERNGECO LLC, Houston, TX (US)

(72) Inventor: Matthe Mathias Contant, Sandvika (NO)

(21) Appl. No.: 16/063,289

(22) PCT Filed: Oct. 5, 2016
(86) PCT No.: PCT/US2016/055593

§ 371 Date: Jun. 17, 2018

Related U.S. Application Data
(60) Provisional application No. 62/270,389, filed on Dec. 21, 2015.

(51) Int. Cl. G01V 1/20

(52) U.S. Cl. CPC G01V 1/201; G01V 2001/207; G01V 2001/204

(57) ABSTRACT

A seismic streamer can include an outer tube that defines an interior space; sensor packages disposed in the interior space; and spacers disposed in the interior space where the spacers include swellable material.

### RELATED APPLICATIONS

This application claims priority to and the benefit of a U.S. Provisional Application having Ser. No. 62/270,389, filed 21 Dec. 2015, which is incorporated by reference herein.

### BACKGROUND

Reflection seismology finds use in geophysics to estimate properties of subsurface formations. Reflection seismology may provide seismic data representing waves of elastic energy, as transmitted by P-waves and S-waves, in a frequency range of approximately 1 Hz to approximately 100 Hz. Seismic data may be processed and interpreted to understand better one or more of composition, fluid content, extent and geometry of subsurface rocks.

### SUMMARY

A seismic streamer can include an outer tube that defines an interior space; sensor packages disposed in the interior space; and spacers disposed in the interior space where the spacers include swellable material. A method can include, in a seismic streamer that includes an outer tube that defines an interior space, sensor packages disposed in the interior space and swellable material disposed in the interior space, exposing the swellable material to fluid; and responsive to the exposing, swelling the swellable material. A swellable spacer for a seismic streamer can include an outer diameter less than approximately 80 millimeters; opposing axial faces that define an axial length less than approximately 15 centimeters; and at least one passage that extends between the opposing axial faces.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates a geologic environment and a technique;

FIG. 2 illustrates multiple reflections and techniques;

FIG. 3 illustrates survey techniques;

FIG. 4 illustrates a portion of a streamer, an accelerometer and a hydrophone;

FIG. 5 illustrates streamer internals;

FIG. 6 illustrates a method and streamer components;

FIG. 7 illustrates a streamer in two states; and

FIG. 8 illustrates methods.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, reflection seismology finds use in geophysics to estimate properties of subsurface formations. Reflection seismology may provide seismic data representing waves of elastic energy (as transmitted by P-waves and S-waves, in a frequency range of approximately 1 Hz to approximately 100 Hz or optionally less than 1 Hz and/or optionally more than 100 Hz). Seismic data may be processed and interpreted to understand better composition, fluid content, extent and geometry of subsurface rocks.

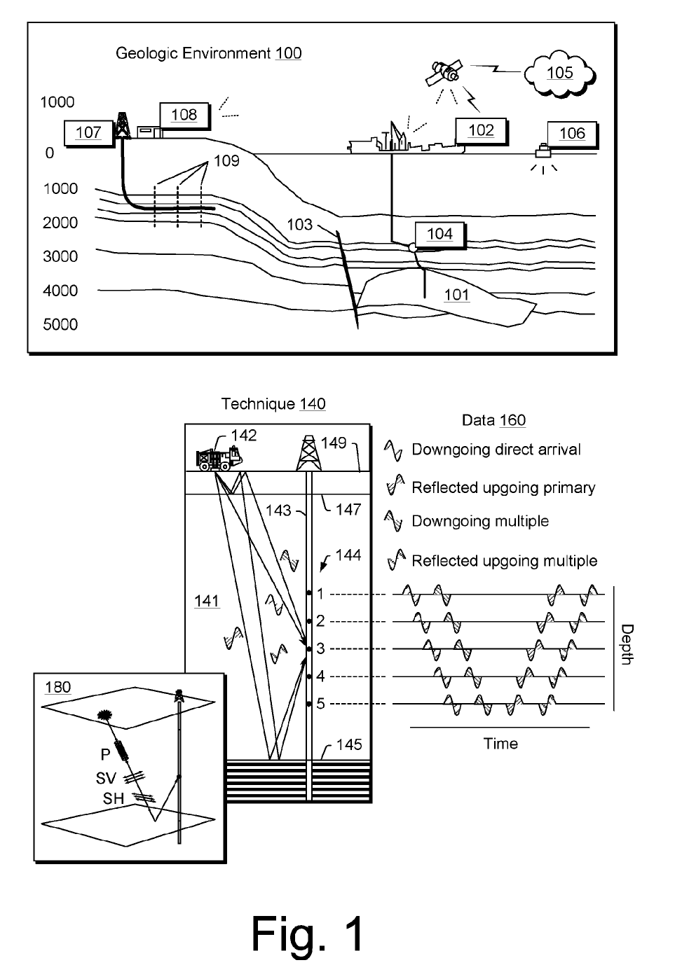

FIG. 1 shows a geologic environment 100 (an environment that includes a sedimentary basin, a reservoir 101, a fault 103, one or more fractures 109, etc.) and an acquisition technique 140 to acquire seismic data (see data 160). A system may process data acquired by the technique 140 to allow for direct or indirect management of sensing, drilling, injecting, extracting, etc., with respect to the geologic environment 100. In turn, further information about the geologic environment 100 may become available as feedback (optionally as input to the system). An operation may pertain to a reservoir that exists in the geologic environment 100 such as the reservoir 101.

The geologic environment 100 may be referred to as or include one or more formations. A formation may be a unit of lithostratigraphy, a body of rock that is sufficiently distinctive and continuous that it can be mapped. In stratigraphy, a formation may be a body of strata of predominantly one type or combination of types where multiple formations form groups, and subdivisions of formations are members.

A system may be implemented to process seismic data, optionally in combination with other data. Processing of data may include generating one or more seismic attributes, rendering information to a display or displays, etc. A process or workflow may include interpretation, which may be performed by an operator that examines renderings of information and that identifies structure or other features within such renderings. Interpretation may be or include analyses of data with a goal to generate one or more models and/or predictions (about properties and/or structures of a subsurface region).

A system may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information.

A system may include add-ons or plug-ins that operate according to specifications of a framework environment. A commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. Various components may be implemented as add-ons (or plug-ins) that conform to and operate according to specifications of a framework environment (according to application programming interface (API) specifications, etc.).

Seismic data may be processed using a framework such as the OMEGA® framework (Schlumberger Limited, Houston, Tex.). The OMEGA® framework provides features that can be implemented for processing of seismic data.

The geologic environment 100 may be outfitted with any of a variety of sensors, detectors, actuators, etc. Equipment 102 may include communication circuitry to receive and to transmit information with respect to one or more networks 105. Such information may include information associated with downhole equipment 104, which may be equipment to acquire information, to assist with resource recovery, etc. Other equipment 106 may be located remote from a well site and include sensing, detecting, emitting or other circuitry. Such equipment may include storage and communication circuitry to store and to communicate data, instructions, etc. One or more satellites may be provided for purposes of communications, data acquisition, etc. FIG. 1 shows a satellite in communication with the network 105 that may be configured for communications, noting that the satellite may additionally or alternatively include circuitry for imagery (spatial, spectral, temporal, radiometric, etc.).

FIG. 1 also shows the geologic environment 100 as optionally including equipment 107 and 108 associated with a well that includes a substantially horizontal portion that may intersect with one or more of the one or more fractures 109; consider a well in a shale formation that may include natural fractures, artificial fractures (hydraulic fractures) or a combination of natural and artificial fractures.

In FIG. 1, the technique 140 may be implemented with respect to a geologic environment 141. As shown, an energy source (a transmitter) 142 may emit energy where the energy travels as waves that interact with the geologic environment 141. The geologic environment 141 may include a bore 143 where one or more sensors (receivers) 144 may be positioned in the bore 143. Energy emitted by the energy source 142 may interact with a layer (a structure, an interface, etc.) 145 in the geologic environment 141 such that a portion of the energy is reflected, which may then be sensed by one or more of the sensors 144. Such energy may be reflected as an upgoing primary wave (or “primary” or “singly” reflected wave). A portion of emitted energy may be reflected by more than one structure in the geologic environment and referred to as a multiple reflected wave (or “multiple”). The geologic environment 141 is shown as including a layer 147 that resides below a surface layer 149. Given such an environment and arrangement of the source 142 and the one or more sensors 144, energy may be sensed as being associated with particular types of waves.

A “multiple” may refer to multiply reflected seismic energy or an event in seismic data that has incurred more than one reflection in its travel path. Seismic data may include evidence of an interbed multiple from bed interfaces, evidence of a multiple from a water interface (an interface of a base of water and rock or sediment beneath it) or evidence of a multiple from an air-water interface, etc.

As shown in FIG. 1, the acquired data 160 can include data associated with downgoing direct arrival waves, reflected upgoing primary waves, downgoing multiple reflected waves and reflected upgoing multiple reflected waves. The acquired data 160 is also shown along a time axis and a depth axis. As indicated, in a manner dependent at least in part on characteristics of media in the geologic environment 141, waves travel at velocities over distances such that relationships may exist between time and space. Thus, time information, as associated with sensed energy, may allow for understanding spatial relations of layers, interfaces, structures, etc. in a geologic environment.

FIG. 1 also shows various types of waves as including P, SV an SH waves.

A P-wave may be an elastic body wave or sound wave in which particles oscillate in the direction the wave propagates. P-waves incident on an interface (at other than normal incidence, etc.) may produce reflected and transmitted S-waves (“converted” waves). An S-wave or shear wave may be an elastic body wave in which particles oscillate perpendicular to the direction in which the wave propagates. S-waves may be generated by a seismic energy sources (other than an air gun). S-waves may be converted to P-waves. S-waves tend to travel more slowly than P-waves and do not travel through fluids that do not support shear. In general, recording of S-waves involves use of one or more receivers operatively coupled to earth (capable of receiving shear forces with respect to time). Interpretation of S-waves may allow for determination of rock properties such as fracture density and orientation, Poisson's ratio and rock type by crossplotting P-wave and S-wave velocities, and/or by other techniques.

Seismic data may be acquired for a region in the form of traces. In FIG. 1, the technique 140 may include the source 142 for emitting energy where portions of such energy (directly and/or reflected) may be received via the one or more sensors 144. Energy received may be discretized by an analog-to-digital converter that operates at a sampling rate. Acquisition equipment may convert energy signals sensed by a sensor to digital samples at a rate of one sample per approximately 4 ms. Given a speed of sound in a medium or media, a sample rate may be converted to an approximate distance. The speed of sound in rock may be of the order of around 5 km per second. Thus, a sample time spacing of approximately 4 ms would correspond to a sample “depth” spacing of about 10 meters (assuming a path length from source to boundary and boundary to sensor). A trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing scenario is divided by two (to account for reflection), for a vertically aligned source and sensor, the deepest boundary depth may be estimated to be about 10 km (assuming a speed of sound of about 5 km per second).

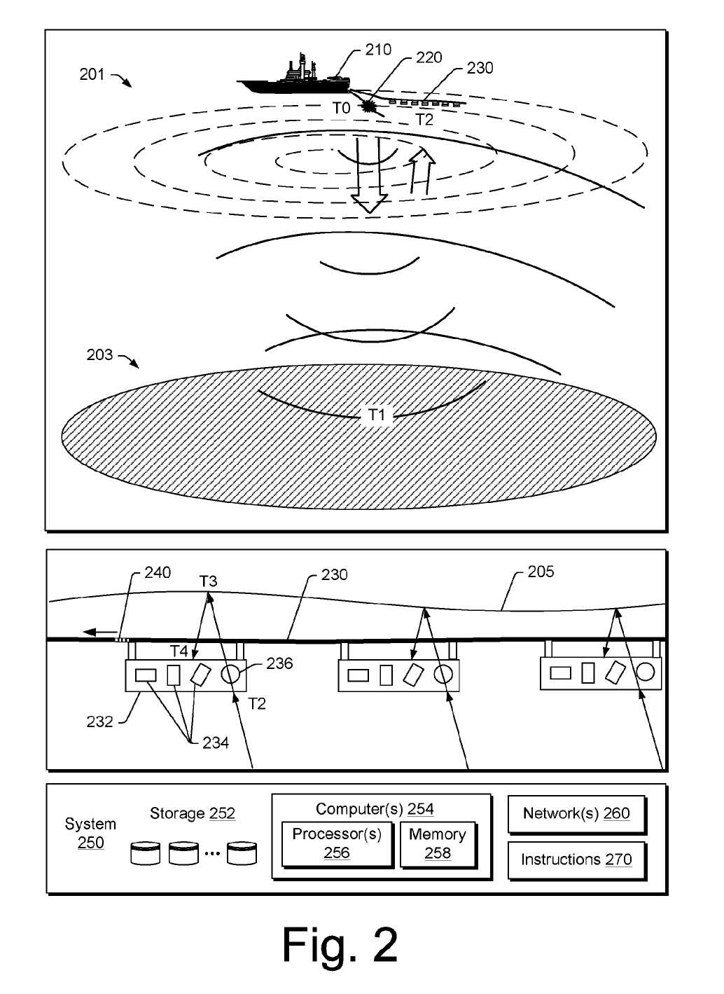

FIG. 2 shows a geologic environment 201 that includes a seabed 203 and a sea surface 205. As shown, equipment 210 such as a ship may tow an energy source 220 and a string of sensors 230 at a depth below the sea surface 205. The energy source 220 may emit energy at a time T0, a portion of that energy may be reflected from the seabed 203 at a time T1 and a portion of that reflected energy may be received at the string of sensors 230 at a time T2.

As mentioned with respect to the technique 140 of FIG. 1, a wave may be a primary or a wave may be a multiple. As shown in an enlarged view of the geologic environment 201, the sea surface 205 may act to reflect waves such that sensors 232 of the string of sensors 230 may sense multiples as well as primaries. In particular, the sensors 232 may sense so-called sea surface multiples, which may be multiples from primaries or multiples of multiples (due to sub-seabed reflections, etc.).

Each of the sensors 232 may sense energy of an upgoing wave at a time T2 where the upgoing wave reflects off the sea surface 205 at a time T3 and where the sensors may sense energy of a downgoing multiple reflected wave at a time T4 (see also the data 160 of FIG. 1 and data 240 of FIG. 2). In such a scenario, sensing of the downgoing multiple reflected wave may be considered noise that interferes with sensing of one or more upgoing waves. An approach that includes summing data acquired by a geophone and data acquired by a hydrophone may help to diminish noise associated with downgoing multiple reflected waves. Such an approach may be employed where sensors may be located proximate to a surface such as the sea surface 205 (arrival times T2 and T4 may be relatively close). The sea surface 205 or a water surface may be an interface between two media; consider an air and water interface. Due to differing media properties, sound waves may travel at about 1,500 m/s in water and at about 340 m/s in air. At an air and water interface, energy may be transmitted and reflected.

Each of the sensors 232 may include at least one geophone 234 and a hydrophone 236. A geophone may be a sensor configured for seismic acquisition, whether onshore and/or offshore, that can detect velocity produced by seismic waves and that can transform motion into electrical impulses. A geophone may be configured to detect motion in a single direction. A geophone may be configured to detect motion in a vertical direction. Three mutually orthogonal geophones may be used in combination to collect so-called 3C seismic data. A hydrophone may be a sensor configured for use in detecting seismic energy in the form of pressure changes under water during marine seismic acquisition. Hydrophones may be positioned along a string or strings to form a streamer or streamers that may be towed by a seismic vessel (or deployed in a bore). Thus, in the scenario of FIG. 2, the at least one geophone 234 can provide for motion detection and the hydrophone 236 can provide for pressure detection. The data 240 (analog and/or digital) may be transmitted via equipment for processing, etc.

A method may include analysis of hydrophone response and vertical geophone response, which may help to improve a PZ summation by reducing receiver ghost and/or free surface-multiple noise contamination. A ghost may be defined as a reflection of a wavefield as reflected from a water surface (water and air interface) that is located above a receiver, a source, etc. (a receiver ghost, a source ghost, etc.). A receiver may experience a delay between an upgoing wavefield and its downgoing ghost, which may depend on depth of the receiver.

A marine cable may be or include a buoyant assembly of electrical wires that connect sensors and that can relay seismic data to the recording seismic vessel. A multi-streamer vessel may tow more than one streamer cable to increase the amount of data acquired in one pass. A marine seismic vessel may be about 75 m long and travel about 5 knots while towing arrays of air guns and streamers containing sensors, which may be located about a few meters below the surface of the water. A so-called tail buoy may assist crew in location an end of a streamer. An air gun may be activated periodically, such as about each 25 m (about at 10 second intervals) where the resulting sound wave travels into the Earth, which may be reflected back by one or more rock layers to sensors on a streamer, which may then be relayed as signals (data, information, etc.) to equipment on the tow vessel.

In FIG. 2, the equipment 210 may include a system such as the system 250. As shown in FIG. 2, the system 250 includes one or more information storage devices 252, one or more computers 254, one or more network interfaces 260 and instructions 270. As to the one or more computers 254, each computer may include one or more processors (or processing cores) 256 and memory 258 for storing instructions (the instructions 270, etc.) executable by at least one of the one or more processors. A computer may include one or more network interfaces (wired or wireless), one or more graphics cards, a display interface (wired or wireless), etc. A system may include one or more display devices (optionally as part of a computing device, etc.).

Pressure data may be represented as “P” and velocity data may be represented as “Z”; noting, however, that the vertical component of a measured particle velocity vector may be denoted “V” and that “Z” may refer to a scaled, measured particle velocity. In various equations presented herein, “V” represents a measured velocity and “Z” represents a scaling thereof.

A hydrophone may sense pressure information (P data) and a geophone may sense velocity information (V and/or Z data). A hydrophone may output signals, optionally as digital data for receipt by a system. A geophone may output signals, optionally as digital data for receipt by a system. The system 250 may receive P and V/Z data via one or more of the one or more network interfaces 260 and process such data via execution of instructions stored in the memory 258 by the processor 256. The system 250 may store raw and/or processed data in one or more of the one or more information storage devices 252.

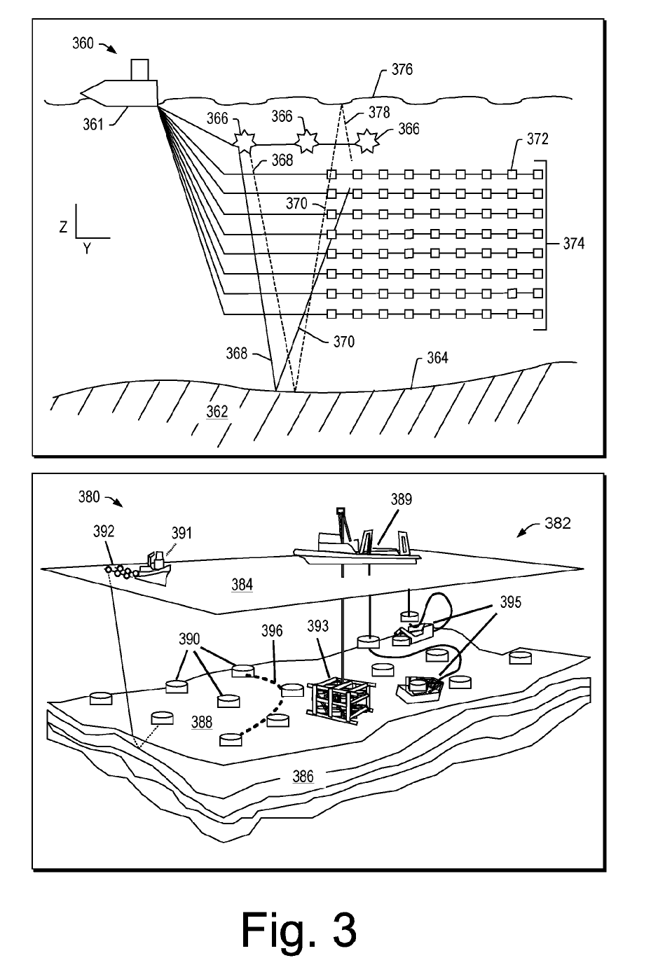

FIG. 3 shows a side view of a marine-based survey 360 of a subterranean subsurface 362 and a perspective view of a marine-based survey 380 of a subterranean subsurface 382.

In the survey 360 of FIG. 3, the subsurface 362 includes a seafloor surface 364. Seismic sources 366 may include marine sources such as vibroseis or air guns, which may propagate seismic waves 368 (energy signals) into the Earth over an extended period of time or at a nearly instantaneous energy provided by impulsive sources. The seismic waves may be propagated by marine sources as a frequency sweep signal. Marine sources of the vibroseis type may initially emit a seismic wave at a low frequency (about 5 Hz) and increase the seismic wave to a higher frequency (about 80 Hz to about 90 Hz or more) over time.

The component(s) of the seismic waves 368 may be reflected and converted by the seafloor surface 364 (as a reflector), and seismic wave reflections 370 may be received by a plurality of seismic receivers 372. Seismic waves may penetrate the subsurface 362 below the seafloor surface 364 and be reflected by one or more reflectors therein and received by one or more of the plurality of seismic receivers 372. As shown in FIG. 3, the seismic receivers 372 may be disposed on a plurality of streamers (a streamer array 374). The seismic receivers 372 may generate electrical signals representative of the received seismic wave reflections 370. The electrical signals may be embedded with information regarding the subsurface 362 and captured as a record of seismic data.

Each streamer may include streamer steering devices such as a bird, a deflector, a tail buoy and the like. One or more streamer steering devices may be used to control streamer position.

In FIG. 3, the seismic wave reflections 370 may travel upward and reach the water/air interface at the water surface 376, a portion of reflections 370 may then reflect downward again (sea-surface ghost waves 378) and be received by the plurality of seismic receivers 372. The sea-surface ghost waves 378 may be referred to as surface multiples. The point on the water surface 376 at which the wave is reflected downward may be referred to as a downward reflection point.

Electrical signals generated by one or more of the receivers 372 may be transmitted to a vessel 361 via transmission cables, wireless communication or the like. The vessel 361 may then transmit the electrical signals to a data processing center. Alternatively, the vessel 361 may include an onboard computing system capable of processing the electrical signals (representing seismic data). Surveys may be of formations deep beneath the surface. The formations may include multiple reflectors, some of which may include dipping events, and may generate multiple reflections (including wave conversion) for receipt by the seismic receivers 372. Seismic data may be processed to generate a seismic image of the subsurface.

A marine seismic acquisition system may tow streamers in the streamer array 374 at an approximate even depth (about 5 m to about 10 m). However, the marine based survey 360 may tow each streamer in streamer array 374 at different depths such that seismic data may be acquired and processed in a manner that avoids the effects of destructive interference due to sea-surface ghost waves. For instance, the marine-based survey 360 of FIG. 3 illustrates eight streamers towed by the vessel 361 at eight different depths. The depth of each streamer may be controlled and maintained using the birds disposed on each streamer.

As to the survey 380 of FIG. 3, a geologic environment 382 is illustrated that includes an air-water surface 384, a formation 386 and a seabed 388 where nodes 390 are positioned on the seabed 384. Equipment may be utilized to position the nodes 390 on the seabed 384 and retrieve the nodes 390 from the seabed 384. Such equipment may include one or more vessels 389, one or more carriers 393 and one or more vehicles 395, which may be autonomous, semi-autonomous, etc. (remotely operated vehicles (ROVs), etc.). A system can include a seismic source vessel 391 that includes one or more seismic sources 392. The seismic source vessel 391 may travel a path while, at times, emitting seismic energy from the one or more sources 392. The nodes 390 can receive portions of the seismic energy, which can include portions that have travelled through the formation 386. Analysis of received seismic energy by the nodes 390 may reveal features of the formation 386.

In FIG. 3, the one or more sources 392 may be an air gun or air gun array (a source array). A source can produce a pressure signal that propagates through water into a formation where acoustic and elastic waves are formed through interaction with features (structures, fluids, etc.) in the formation. Acoustic waves can be characterized by pressure changes and a particle displacement in a direction of which the acoustic wave travels. Elastic waves can be characterized by a change in local stress in material and a particle displacement. Acoustic and elastic waves may be referred to as pressure and shear waves, respectively; noting that shear waves may not propagate in water. Collectively, acoustic and elastic waves may be referred to as a seismic wavefield.

Material in a formation may be characterized by one or more physical parameters such as density, compressibility, and porosity. In the geologic environment 382 of FIG. 3, energy emitted from the one or more sources 392 can be transmitted to the formation 386; however, elastic waves that reach the seabed 388 will not propagate back into the water. Such elastic waves may be received by sensors of the nodes 390. The nodes 390 can include motion sensors that can measure one or more of displacement, velocity and acceleration. A motion sensor may be a geophone, an accelerometer, etc. As to pressure waves, the nodes 390 can include pressure wave sensors such as hydrophones.

Various nodes of the nodes 390 may optionally be coupled via a cable or cables 396. A cable may include one or more sensors. A cable that extends from, to, between, etc., one or more nodes may optionally include one or more sensors that may include one or more geophones, one or more hydrophones, etc.

The nodes 390 can include sensors for acquiring seismic wavefield information at the seabed 388. Each of the nodes 390 can include one or more hydrophones and/or one or more motion sensors (one or more geophones, one or more accelerometers, etc.).

A node may include circuitry that can include circuitry that can digitize (analog to digital conversion ADC circuitry) and record signals (a microcontroller, a processor, etc., operatively coupled to memory). Each of the nodes 390 can include a housing, sensors, one or more microcontrollers or processors, one or more batteries, memory, ADC circuitry, a compass, communication circuitry, etc. Various components of a node may be operatively coupled via wires, connectors, etc. A node can include one or more circuit boards (printed circuit boards) that can provide for electrical connections between various components, etc.

A 3D VSP technique may be implemented with respect to an onshore and/or an offshore environment. An acquisition technique for an onshore (land-based) survey may include positioning a source or sources along a line or lines of a grid; whereas, in an offshore implementation, source positions may be laid out in lines or in a spiral centered near a well.

A 3D acquisition technique may help to illuminate one or more 3D structures (one or more features in a geologic environment). Information acquired from a 3D VSP may assist with exploration and development, pre-job modeling and planning, etc. A 3D VSP may fill in one or more regions that lack surface seismic survey information due to interfering surface infrastructure or difficult subsurface conditions, such as shallow gas, which may disrupt propagation of P-waves (seismic energy traveling through fluid may exhibit signal characteristics that differ from those of seismic energy traveling through rock).

As mentioned, one or more survey techniques can include use of one or more streamers. Streamers can be towed at spatial distances in a range of between about 50 meters and about 200 meters. In such a scenario, sampling in a crossline direction may be in a range of about 16 times to about 64 times sparser than an inline direction.

A streamer can include point-receiver circuitry. A point-receiver approach can combine hydrophones with tri-axial microelectromechanical system (MEMS) accelerometers. In such a streamer, the MEMS accelerometers can measure a substantial bandwidth of particle acceleration due to up- and down-going seismic wavefields. Measurements of particle acceleration can be directly related to a gradient in a pressure wavefield. A streamer may include the ISOMETRIX™ technology, which includes point-receiver circuitry (Schlumberger Limited, Houston, Tex.).

A streamer may include particle motion sensors that are sensitive to acoustical vibrations within a streamer cable. Streamer technology can account for one or more noise modes that may propagate along at least a portion of a streamer. A noise mode can depend on one or more factors. A noise mode can depend on streamer construction and sensor positioning.

A streamer may be implemented to perform dense single-sensor sampling of accelerometers. Such an approach can allow for accurately characterizing and removing one or more noise modes at least in part at low frequencies. One or more technologies and/or methods can provide for suppression of noise. Noise suppression can provide reliable signal from accelerometers below about 10 Hz. Where a system includes a spread of about 12 streamers of about 8 km lengths, such a system can include over about 500,000 active sensors. In such an arrangement, an acquisition system can provide for continuously recording of individual shots that are part of a seismic survey. A method can include storing data and/or processing data.

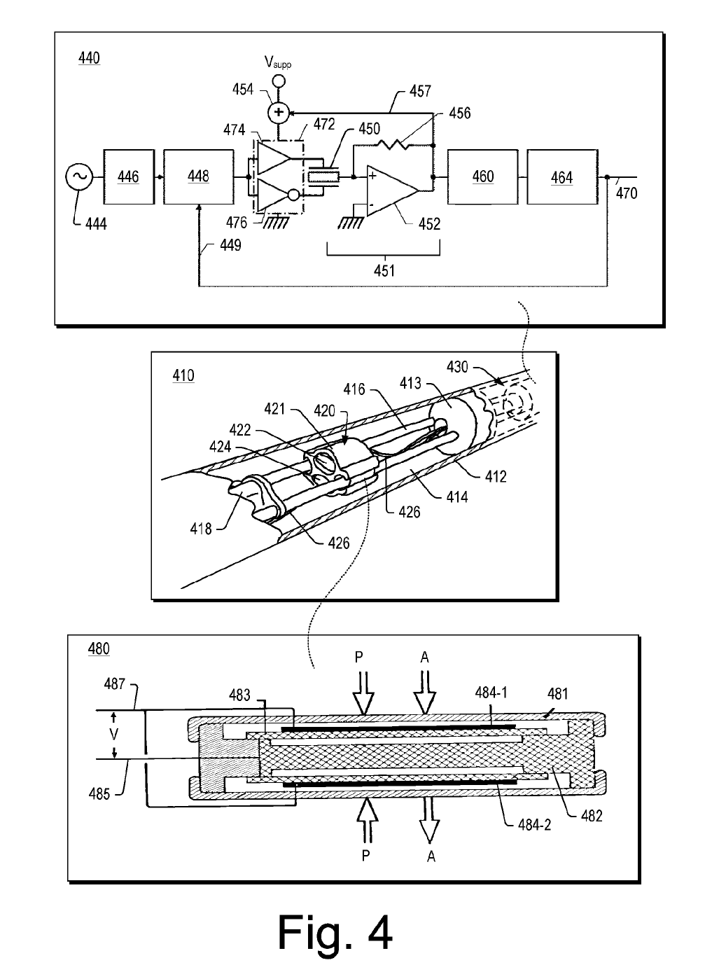

FIG. 4 shows a portion of a streamer cable 410, an accelerometer 440 and a hydrophone 480. As shown in FIG. 4, the streamer cable 410 can include an outer tube 412 with one or more spacers 413 that define a chamber 414, strength ropes 416, a fixture 418, a pressure sensor package 420 and a velocity sensor package 430. As shown, the pressure sensor package 420 can includes a housing 421 and one or more pressure sensors 421 and 422 that are disposed at least in part in the housing 421. The housing 421 can include clips that can couple the housing 421 to the strength ropes 416, which can help to locate the pressure sensor package 420 within the chamber 414 defined by the outer tube 412. As shown, one or more wires 426 can be operatively coupled to the one or more pressure sensors 421 and 422 and/or to one or more velocity sensors of the velocity sensor package 430. The wires 426 can run though the spacer 413 and the fixture 418, both of which may also accommodate the strength ropes 416. The velocity sensor package 430 can include a housing that is supported within a chamber of the outer tube 412 (optionally a chamber that does not include a pressure sensor package, etc.).

Two of the spacers 413 can define an axial dimension of the chamber 414. The chamber 414 can be at least partially filled with a fluid or fluids and/or one or more other materials (gel, etc.). The streamer cable 410 can include silicone oil in the chamber 414.

One or more of the accelerometers 440 may be included in the velocity sensor package 430. As to the pressure sensor package 420, while labels are illustrated for the two sensors 422 and 424, the pressure sensor package 420 can include a single pressure sensor or more than two pressure sensors. More than one sensor package may be included in a chamber where the sensor packages in the chamber may optionally differ (as to sensor type, etc.). The streamer cable 410 can include a plurality of pressure sensors (hydrophones) and a plurality of particle velocity sensors (geosensors or accelerometers).

As shown in FIG. 4, the accelerometer 440 can include a system clock generator 444, a jitter filter 446, a pulse generator 448, a return connection 449, a sensor 450, a charge amplifier 451, an adder 454, a resistor 456, an adder connection 457, an amplitude detector 460, a loop controller 464, a digital output 470 and logic 472 with complimentary drivers 474 and 476. The accelerometer 440 can be part of a seismic sensor cable (a streamer, etc.).

In FIG. 4, the accelerometer 440 can include a capacitive MEMS-based sensor. As illustrated in FIG. 4, the sensor 450 can include an armature and a pair of fixed position electrodes attached to the armature. A sensor may include a differential capacitor, in which a mobile electrode moves along a sensitive axis in response to an external acceleration.

The accelerometer 440 may be subjected to inertial forces caused by an external acceleration where a proof mass may be kept in an equilibrium position by electrostatic forces controlled via feedback circuitry. In FIG. 4, the amplitude detector 460 and the loop controller 464 can provide a substantially high gain where residual movement of a mobile mass with respect to its equilibrium position may be kept close to a null point. Magnitude and direction of a net restoring force can be a difference between attractive forces working in opposite directions.

Sampling noise can be kT/C noise (thermal noise), which can be introduced by switching and can degrade a dynamic range of a sensor. In FIG. 4, the accelerometer 440 can include the charge amplifier 451 configured with an input terminal that is continuously connected to a mobile electrode (during times in which the sensor 450 receives both actuation and activation voltages). Sampling noise can be reduced in comparison to circuitry that does not include such a configuration of components.

In FIG. 4, the accelerometer 440 can include a constant charge drive for the sensor 450. The charge amplifier 451 of the accelerometer 440 can modulate, or adjust, actuation voltage based on a proof mass movement, which may thereby increase available signal-to-noise ratio. As shown in FIG. 4, a feedback network can be associated with the charge amplifier 451. An output terminal of the amplifier 452 can be connected via the adder connection 457 to the adder 454, which can combine an output signal from the amplifier 452 with a supply voltage Vₛᵤₚₚ. In such an arrangement, the supply voltage that is applied to the logic 472, from the adder 454, can be modulated according to a sensed signal that as available at the output terminal of the amplifier 452; and as a result, the actuation force can be independent of the proof mass movement.

A sensor package may include a three component (3C) particle motion sensor assembly; consider a 3C accelerometer assembly. Such an assembly may acquire inline (x), crossline (y) and vertical (z) particle acceleration measurements; consider an accelerometer assembly that includes microelectromechanical system (MEMS) sensor units that sense accelerations along respective inline (x), crossline (y) and vertical (z) axes. In a package, orientations of MEMS sensor units may be appropriately varied for purposes of alignment with corresponding axes.

In FIG. 4, as shown in an approximate cross-sectional view, the hydrophone 480 can include a sheath 481, a core 482, an electrode 483 and at least one piezoelectric element 484-1 and 484-2, which may be a ceramic-based piezoelectric element or elements. As shown, a potential (V) may be measured across wires 485 and 487 where the potential (V) varies based at least in part on response of the at least one piezoelectric element 484-1 and 484-2 to external forces such as pressure and/or acceleration. A current-based sensor may be utilized where a change in current indicates a change in a measured variable, etc.

A piezoelectric material can produce an electrical potential when it is subjected to physical deformation. A piezoelectric material can include a crystalline structure (quartz, tourmaline, a poly-crystalline ceramic, etc.). A lead zirconate titanate (PZT) may be utilized.

A hydrophone can include a plate of piezoelectric ceramic placed on an elastic electrode. In such an arrangement, the active element can be deformed by pressure variations in surrounding water and produce a voltage collected between the electrode and a terminal bonded to the other face and the electrode can rest on a metallic core that supports its ends and that may also limit its maximum deformation (to avoid damage to the ceramic). A hydrophone can be configured to preserve integrity even where it may be accidentally submitted to high pressures such as when a streamer breaks and drops to the bottom.

As the active element has mass, it can produce a voltage when it is subjected to acceleration. In off-shore operations, with boat movements and waves, a hydrophone can be subjected to accelerations, which can create noise in the absence of application of a compensation technique. To diminish the effect of acceleration, a hydrophone can be assembled with elements that may be paired, as shown in FIG. 4 (see elements 484-1 and 484-2 with respect to the direction of acceleration). In such a scenario, voltage produced by acceleration can cancel whereas voltage produced by pressure can add.

As mentioned, streamer cable can be at least partially filled with a material (a fluid, a gel, etc.). An outer tube or jacket may be of the order of a few millimeters thick. An outer tube may be constructed of a material or materials that provide integrity while allowing for responsiveness as to sensing. Issues that may arise at sea include shark bites and other physical hazards that may be encountered during towing, storage and deployment.

Streamer cables may be spooled onto drums for storage on a vessel, which subjects the streamer cables to various contact and bending forces, etc. (consider winding and unwinding operations).

A streamer cable may be serviceable in that repairs may be made. Such repairs may be at sea or at a land-based facility. In general, operations aim to avoid or otherwise diminish down time due to expense and costs (vessel, crew, production schedules, etc.). In various geographies, weather may vary and particular conditions, seasons, etc. may cause some amount of uncertainty in scheduling. In some geographies, regular “windows” exist where conditions can be more favorable for performing surveys.

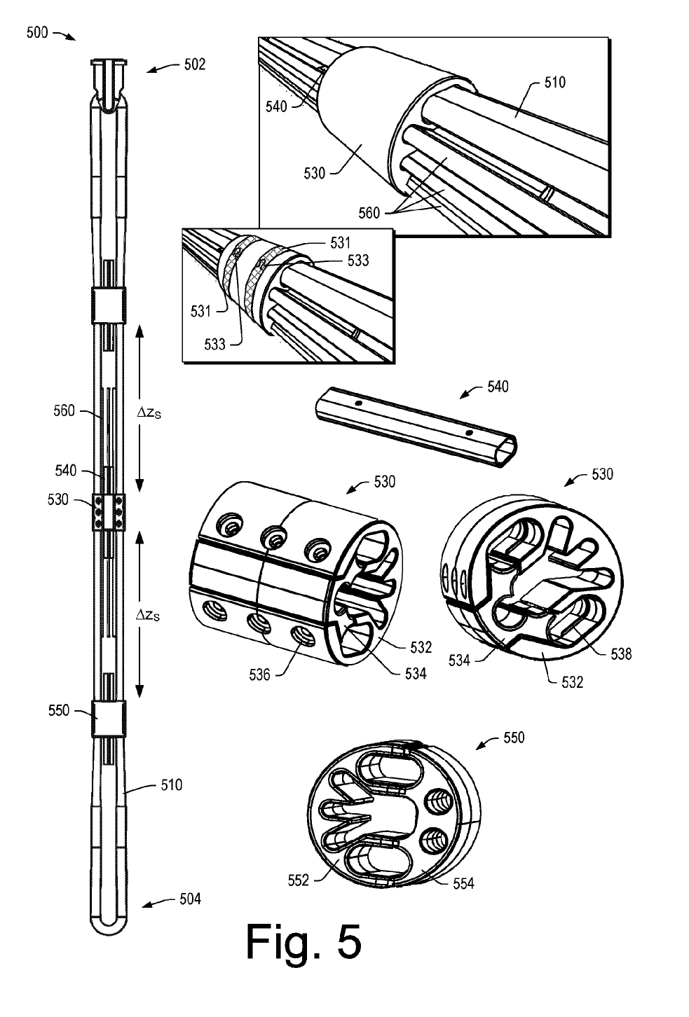

FIG. 5 shows streamer internals 500 that include a proximate end 502 and a distal end 504. The proximate end 502 may be operatively coupled to a towline, etc. The streamer internals 500 can be a portion of a streamer or a segment of a streamer; consider a streamer that includes a plurality of segments where each segment has a length that may be of the order of meters. A streamer can include a plurality of segments to have an overall length of the order of hundreds of meters (a kilometer or more).

In the streamer internals 500, a strength rope 510 is formed as a loop that extends from the proximate end 502 to the distal end 504 and from the distal end 504 to the proximate end 502. Such a strength rope 510 may be a continuous rope or may be rope portions coupled to together (using one or more couplings, etc.).

The streamer internals 500 can include components that are coupled to (carried by) the strength rope 510. Components can include one or more types of spacers 530 and 550. A spacer can “space” a housing 540 and/or wires 560 (electrical wires and/or one or more optical fibers) within an internal space defined by an outer tube of a streamer where streamer internals can reside. A spacer can maintain a geometric arrangement of internal components of a streamer within a bore of a tube of a streamer (a lumen of a tube), which may be an outer tube that includes an exterior surface that is exposed to an internal environment. An interior surface of a tube may optionally be of a different material, coating, finish, etc., than that of an exterior surface of the tube. An interior surface can be a finish with desired frictional characteristics (low friction with respect to outer surfaces of a spacer, etc.).

In FIG. 5, the streamer internals 500 can include one or more swellable materials. One or more of the one or more types of spacers 530 and 500 may include one or more swellable materials. A spacer may be made as a single piece spacer or as a multi-piece spacer where at least one portion (at least one piece, etc.) is made from a swellable material. A swellable material can include a matrix that can imbibe fluid (“solvent”) that results in an increase in volume when the matrix is free to swell, and a development of force when the matrix is constrained by one or more surrounding materials. A spacer can be of a size that provides for an amount of free swelling when installed in a streamer as a streamer internal component and that provide for development of force after a certain amount of free swelling has occurred.

FIG. 5 shows where the spacer 530 may optionally be fit with one or more annular portions 531. A spacer may optionally be a multi-piece spacer with a core or base portion that can receive one or more annular portions. In such an arrangement, the spacer may include one or more annular grooves that can seat one or more annular portions (one or more ring portions). An annular portion can be a split annular portion (a split ring) that can include key and keyway features at the split ends. The one or more annular portions 531 are shown in FIG. 5 as including key and keyway features 533. A key can include a head and a keyway can include a head-shaped socket that can receive the head. Where a split annular portion is a swellable portion of a spacer, swelling can occur that may increase force between key and keyway features and increase locking thereof. An annular portion with key and keyway features may be utilized to lock a single piece base portion, which may include a slit or slits and/or may be utilized to lock a multi-piece base portion. One or more swellable annular portions may be utilized additionally or alternatively to one or more other types of locking features of a spacer.

In FIG. 5, the spacer 530 is shown as optionally including two pieces 532 and 534 such that the pieces 532 and 534 may be in a disassembled state, positioned about various components and then joined to be in an assembled state. As mentioned, a spacer can include a locking mechanism that locks pieces together. The spacer 530 includes bolt or screw bores 536 that can receive bolts or screws to lock the pieces 532 and 534 together. A spacer may be a single piece spacer that includes a slit or slits that can be spread to accommodate a housing, a wire, a fiber, etc. In FIG. 5, the spacer 530 includes keys 538 that may engage the rope 510, which may include a keyway or keyways. A spacer can include one or more keys and/or one or more keyways and a component may include one or more keyways and/or one or more keys such that a space can be coupled to a component and/or vice versa to locate the spacer and component axially with respect to each other and radially and/or azimuthally (to help maintain alignment of components during assembly, use, etc.).

In FIG. 5, the streamer internals 500 can be disposed along a length of a streamer that can be defined by a z-axis. In such an arrangement, one or more axial spacings between spacers may be defined by a dimension or dimensions Δzₛ. Such a dimension may be of the order of ten centimeters or tens of centimeters. For a streamer segment of about 100 meters in length, the streamer segment may include one hundred or more spacers; consider a streamer segment with about four hundred spacers over about 100 meters (spacing center-to-center of about 25 centimeters). A streamer outer tube may be of a diameter of the order of tens of millimeters (about 20 millimeters to about 80 millimeters). A streamer can include a number of sensors, which may be spaced axially; consider about 64 3-axis accelerometers (3C geophones) and about 32 hydrophones; noting that other arrangements, types of sensors, number of sensors, etc., may be included in a streamer. Such sensors may be within respective housings (see the housing 540) and operatively coupled to one or more wires, fibers, etc. (see the wires 560). Wires and/or fibers may be individually spaced and/or gathered together with a sheath or other binding material about them.

As mentioned, a streamer can include one or more materials that can swell; consider a streamer that includes a rubber or another type of material that can swell when exposed to a fluid, a gel, etc. A swellable material may swell when exposed to oil, which may be a silicone oil. A swellable material may swell when exposed to water. A swellable material may swell when exposed to a filler material that is present in a seismic streamer (an oil, a gel, etc.).

One or more of the spacers 530 and 550 of the streamer internals 500 may be swellable. At least a portion of a spacer may swell in response to exposure to a filler material that may be a liquid filler material (a filler fluid, which may be referred to as a “solvent” with respect to a swellable material matrix). Chambers may be formed by swelling of one or more spacers. A chamber may be formed over one of the lengths Δzₛ as shown in FIG. 5 when a tube is provided to contain the internals.

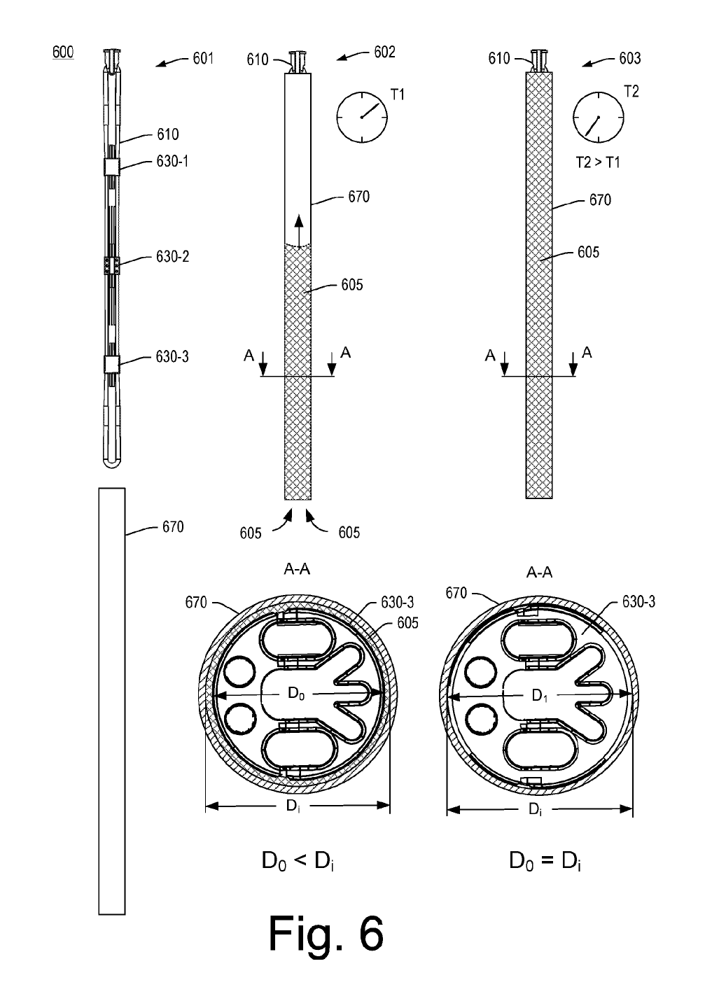

FIG. 6 shows a method 600 that includes an assembly process 601 for assembling streamer internals 610 with respect to a tube 670 to form an assembly, a filling process 602 for filling space within the assembly with fluid 605 (via flowing, pumping, pulling, etc.) to form a fluid filled assembly, and a swelling process 603 for swelling spacers 630-1, 630-2 and 630-3 in the fluid filled assembly in response to contact with the fluid to form chambers within the fluid filled assembly to form a compartmentalized streamer.

In FIG. 6, approximate cross-sectional views are shown along a line A-A. As to the filling process 602, the tube 670 includes an inner diameter Dᵢ and the spacer 630-3 includes an outer diameter D₀ that is less than Dᵢ. In such an approach, the internals can be assembled with respect to the tube 670 with a desired amount of clearance between spacer outer diameter and tube inner diameter. An air or gas blowing process may be used to facilitate the assembly of the assembly process 601. The tube 670 may be pressurized via air to maintain the tube 670 in an uncollapsed state such that the interior of the tube 670 can be at or near its inner diameter for receipt of the streamer internals (by pulling the internals in, pulling the tube over or a combination of both).

At the time of the filling process 602, which may be of the order of hours, the spacer 630-3 may be approximately at its unswollen outer diameter. Such an approach can help to assure that the spacer 630-3 does not impede flow of fluid during filling. As shown, a clearance exists, which may be eccentric due to gravity, etc. Such a clearance can allow for flow of fluid in an axial direction during the filling process 602. As mentioned, such a clearance can facilitate assembly during the assembly process 601 as well. A method may optionally include a combined assembly and filling process where a fluid may help to reduce friction and lubricate one or more surfaces to facilitate assembly.

As to the swelling process 603, it can commence at a time of filling, however, with kinetics that do not interfere with a selected filling time in terms of duration. Swelling kinetics can be slow when compared to time of filling. In FIG. 6, a time T1 is shown as being associated with the filling process 602 and a time T2 is shown as being associated with the swelling process 603. As indicated, T2 is greater than T1 such that swelling does not interfere with filling. The time T2 may be hours or days after the time at which the filling process 602 is completed (consider a time T1′ being greater than T1 yet less than T2).

In the cross-sectional view along the line A-A in the swelling process 603, the outer diameter of the spacer 603-3 is approximately equal to the inner diameter of the tube 670. The spacer 603-3 can form a seal with respect to the tube 670 such that flow of fluid from on axial side of the spacer 603-3 to another axial side of the spacer 603-3 is hindered. A small amount of fluid may possibly pass, however, such an amount is expected to be minimal where the tube 670 may be ruptured, punctured, etc. as to one compartment (chamber) such that fluid from an adjacent compartment (chamber) does not readily leak and flow into the damaged compartment. A rate of flow may be sufficient slow to allow an adjacent chamber to continue to operate during a survey where a streamer is being towed (over a period of hours or days).

A swelling process may occur at least in part while a streamer is coiled about a spool. A swelling process may be facilitated by temperature according to an Arrhenius relationship (where rate of swelling increases with increasing temperature). A swelling process may occur during transit of a streamer. A swelling process that compartmentalizes a streamer may be substantially complete or complete prior to deployment of the streamer in an aqueous environment.

A streamer can include a contiguous space that extends over a plurality of chambers. In such a streamer, where an outer tube is penetrated, fluid within the contiguous space may flow out of the streamer (due to pressure, displacement, etc.); consider a shark bite that punctures an outer tube of a streamer. Fluid within a contiguous space can begin to exit via puncture holes and/or tears, etc., which may be 360 degrees about an axis of a streamer. As the fluid exits, individual chambers may become at least in part gas filled and/or filled with water. Alteration of an environment of a sensor package can, in turn, alter response of one or more sensors of the sensor package.

Where a seismic streamer includes one or more swellable materials, upon damage to an outer tube, one or more of the one or more swellable materials may swell and act to compartmentalize a damaged region from one or more other regions. Where a portion of an outer tube is damaged at an axial position corresponding to a chamber, water may enter that chamber by displacing fluid (silicone oil, etc.) where swellable material is exposed to the water, which, in turn, causes the swellable material to swell (increase in volume) to seal off or otherwise diminish flow of fluid from one or more adjacent chambers to the damaged chamber.

A seismic streamer can include different types of swellable materials. One type may swell in response to contact with a filler material and another type may swell in response to contact with water such as sea water.

In FIG. 6, one or more of the spacers 630-1, 630-2 and 630-3 can include one or more keys and/or one or more keyways that may engage a rope or ropes, which may include a keyway or keyways. A spacer can include one or more keys and/or one or more keyways and a component may include one or more keyways and/or one or more keys such that a space can be coupled to a component and/or vice versa to locate the spacer and component axially with respect to each other and radially and/or azimuthally (to help maintain alignment of components during assembly, use, etc.). One or more clips may be utilized to locate a spacer with respect to a rope, a housing, a wire, a fiber, etc. A swellable spacer may be itself looser fitting at a time prior to swelling. In such an arrangement, one or more mechanisms may be utilized to maintain a position of a spacer during assembly (assembly with respect to a tube) such that the spacer does not substantially change its axial position (less than a centimeter, etc.) during assembly. Upon swelling, a spacer may become substantially fixed with respect to its axial position due to contact with an inner surface of a tube and/or one or more other components, which may pass through features, openings, etc., in the spacer.

A dissolvable band may be placed about a swellable spacer where fluid causes the band to dissolve and where the fluid causes the spacer to swell.

A swellable spacer can be a swellable material that swells in response to contact with an oil, which may be a hydrocarbon oil, a silicon oil, etc. A hydrocarbon oil can be kerosene, which is a fluid with a density of about 0.8 grams per cubic centimeter (composed of carbon chains between about 6 and about 16 carbon atoms per molecule). A fluid can be or include one or more types of aliphatic hydrocarbons (non-aromatic compounds). A fluid may be selected based on density and based on ability to swell a swellable spacer. A fluid may be selected to have a density that is less than approximately 0.95 grams per cubic centimeter to provide an amount of buoyancy to a streamer where a portion of the fluid may enter into a polymeric matrix of a spacer disposed within an interior space defined by an outer tube of a streamer to cause expansion of the polymeric matrix spacer.

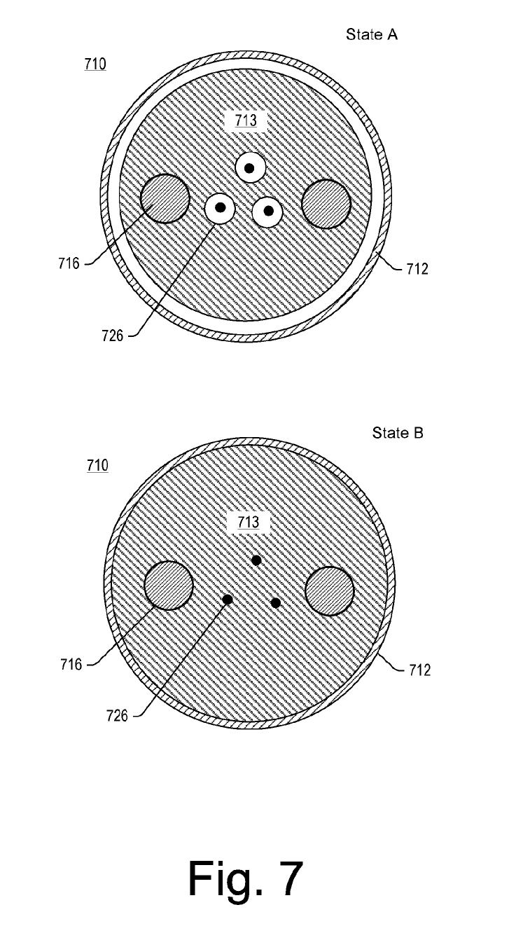

FIG. 7 shows approximate cross-sectional views of a streamer 710 in State A and State B. As shown, the streamer 710 includes an outer tube 712, a spacer 713, strength ropes 716 and wires 726. In State A, the spacer 713 includes bores with radii that are sufficiently large for passage of the wires 726 and for passage of fluid that may be in chambers of the streamer 710. Further, the spacer 713 includes an outer diameter that is less than an inner diameter of the outer tube 710, which may allow for passage of fluid that may be in chambers of the streamer 710.

In FIG. 7, State B corresponds to a swollen state of the spacer 713 where the bores have smaller radii or cross-sectional area and where the outer diameter of the spacer 713 is larger and substantially equal to the inner diameter of the outer tube 712. In such a scenario, the spacer 713 includes a material that is swellable upon exposure to one type of fluid or optionally more than one type of fluid (oil, water, etc.). As the material swells, it may be constricted by the outer tube 712 such that inner bores diminish in cross-sectional area. The material may swell and “clamp down” on the wires 726 to effectively seal the bore or otherwise reduce fluid transport therethrough.

The spacer 713 may include a bore insert which may be made of or include a swellable material where, upon assembly, such a swellable bore insert may be disposed within a bore of a spacer (before or after wires are threaded through the bore). A spacer may include a plurality of bores where swellable material may diminish the ability of such bores to transport fluid (silicone oil, etc.).

Where a seismic streamer includes at least one swellable material, upon damage to the seismic streamer (puncture of the outer tube, etc.), the swellable material may be of a type that can swell and act to compartmentalize the streamer into one or more smaller sections with the aim to prevent losing functionality of a larger portion of the streamer.

A silicone oil filled seismic streamer can include an outer tube, strength ropes, electric cabling and sensors, plastic housings and/or spacers that act to center or otherwise locate one or more components (sensors, etc.) and silicone oil. Such a silicone oil filled seismic streamer can include swellable spacers that swell in response to contact with the silicone oil. Swellable spacers can compartmentalize such a streamer such that a breach in a compartment remains localized by swollen spacers.

A method can include assembling internals of a streamer to form a section with an axial length of about 100 meters. Such a method can include pulling the internals in to an outer tube and filling the tube with an appropriate fluid (a type of oil, etc.)

Where at least a section of a seismic streamer experiences a puncture to its outer tube, at least some of the fluid within a contiguous space of the seismic streamer can run out. Where the section is about 100 meters in length, that section may become practically inoperable for acquiring data. Further, as fluid exists, which may be oil, an oil spot may be observed in the water (sea water, etc.), which may be undesirable as well. A streamer with swellable spacers can reduce leakage by reducing leakage to damaged compartments defined by spacing between swellable spacers.

As explained with respect to FIG. 6, a streamer can be compartmentalized into numerous smaller sections such that damage associated with a puncture can be restricted to a smaller portion of the streamer.

A State A to State B type of transition may occur responsive to damage to an outer tube and/or a transition from State A to State B may occur upon filling of a streamer during an assembly or preparation process. Where an oil is utilized to fill space within a streamer, a swellable material may swell upon exposure to such oil. The oil may be a hydrocarbon oil and/or another type of oil (a silicone oil, etc.). In such a scenario, the swellable material may swell at a rate that is relatively slow compared to a filling process such that swelling does not practically impact filling.

A swellable material may be tailored to swell over a period of hours whereas a filling process may be performed in a lesser amount of time. A method can include filling a streamer with fluid and allowing for swelling of swellable material in the streamer that can swell and compartmentalize the streamer. An outer tube may be of a particular elasticity such that a volume increase due to swelling of swellable material, which may force fluid into a chamber, etc., does not overly stress the outer tube.

A spacer can include a relatively small bore sized sufficiently to allow for passage of one or more wires (and/or one or more fibers) and fluid upon filling of a contiguous space in a streamer. In such a scenario, a bore liner material may swell upon exposure to the fluid and thereby decrease the cross-sectional area of the bore and form a seal about wires that pass through the bore.

A streamer can include a number of compartments that may be of the order of about one hundred or more; consider a 100 meter long streamer section with about 200 compartments. In such an arrangement, individual compartments may be of the order of about 0.5 meter in axial length; noting that compartment length may vary depending on type of sensor or sensors in a compartment, etc. Where a compartment includes one sensor package, damage to that compartment may act to make that one sensor package practically inoperable. In such an arrangement, the amount of fluid that may leak from the streamer may be limited to the volume of a single compartment (an oil spot may be no larger than about the corresponding volume of oil in a particular compartment). Compartmentalization may reduce risk of change in properties of a streamer; consider properties such as buoyancy properties.

A streamer may perform adequately where compartmentalization is utilized and the streamer experiences a bite or other type of puncture. Such a streamer may maintain a relative balance that corresponds to a particular depth; whereas, an uncompartmentalized streamer may experience substantial leakage of internal fluid to an external environment such that buoyancy and depth are impacted to an extent that the streamer or a large portion thereof (about a 100 meter section, etc.) does not perform adequately.

A swellable material may be used to fabricate a spacer. A swellable material may be used to fabricate a portion of a spacer. A swellable material may be used to fabricate a bore liner for insertion at least in part into a bore of a spacer.

A streamer can include a plurality of spacers disposed at axial positions along the streamer where a distance between the spacers is about 0.5 meters. In such a streamer, the spacer could be made of a swellable rubber. Such rubber may be formed as blocks that can be transfer molded off-line and used additionally and/or alternatively to spacers, which may be plastic spacers. A streamer may include plastic spacers and rubber blocks that are made of swellable rubber. A number of spacers and a number of swellable rubber blocks may be selected and utilized to compartmentalize a streamer.

A swellable material can be an oilfield swellable elastomer or elastomer system that can swell upon exposure to hydrocarbons.

A swellable material can be a swellable elastomer or elastomer system that can swell upon exposure to silicone oil.

A swellable material can be a water swellable elastomer or elastomer system that can swell upon exposure to one or more types of aqueous fluids.

An assembly procedure can include filling a streamer with oil, allowing time for swellable material (swellable rubber, etc.) to swell. In such an approach, swelling may occur over a period of time that can be in a range from of the order of hours to of the order of days. Due to the swelling, the swellable material expands and seals against an inside surface of the outer tube of the streamer and/or to diminish size of one or more bores (utilized for assembly such as passage of wires, strength ropes, etc.). As a swellable material swells, it may seal around one or more internal electrical cables (wires, etc.) and strength ropes. Where a streamer includes one or more optical fibers, a swellable material may swell and form a seal about such one or more optical fibers.

A streamer can include one or more types of rubbers or other materials that swell under influence of oil, water or other liquids or gels in a seismic streamer.

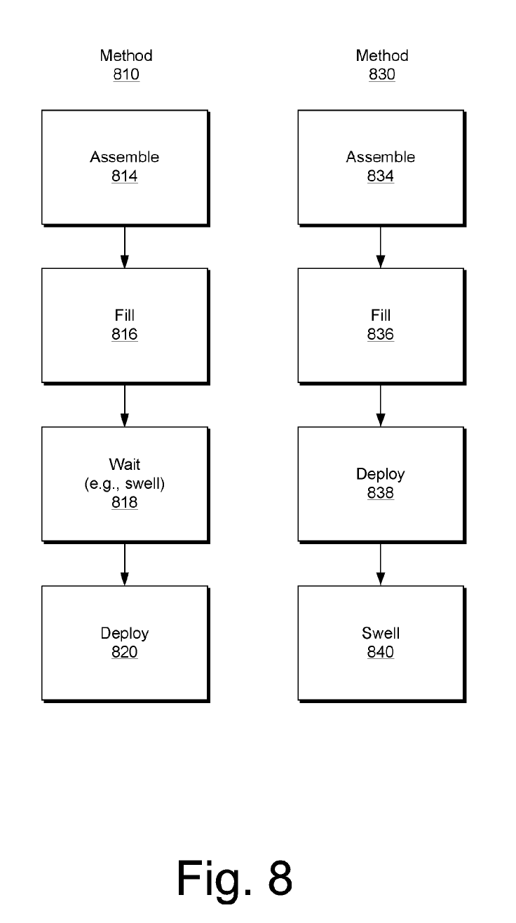

FIG. 8 shows a method 810 and a method 830. As shown, the method 810 includes an assembly block 814 for assembling a streamer, a fill block 816 for filling a space within the streamer with a fluid, a wait block 818 for waiting for swellable material in the streamer to swell upon exposure to the fluid and a deployment block 820 for deploying the streamer for a survey. In such a scenario, the swellable material can compartmentalize portions of the streamer. A contiguous space that spans an axial length of the streamer can be compartmentalized into compartments that may lack fluid communication with one or more other compartments.

As shown in FIG. 8, the method 830 includes an assembly block 834 for assembling a streamer, a fill block 836 for filling a space within the streamer with a fluid, a deployment block 838 for deploying the streamer for a survey in an aqueous fluid environment and a swell block 840 for swelling material in the streamer upon exposure to the aqueous fluid. In such an approach, the swellable material can compartmentalize portions of the streamer. A contiguous space that spans an axial length of the streamer can be compartmentalized into compartments that may lack fluid communication with one or more other compartments.

A swellable material can be or include a swellable elastomer; consider a swellable elastomer that is a cross-linked polymer network that can imbibe fluid “solvent”), resulting in an increase in volume when the polymer is free to swell, and a development of force when the polymer is constrained by one or more surrounding materials.

A streamer can include one or more elastomers that can expand and form an annular seal or seals when exposed to a fluid or fluids. An elastomer may be oil- or water-sensitive. An oil may be a hydrocarbon oil or another type of oil (silicone oil, etc.). Expansion rates and pressure ratings may be affected by one or more factors. Oil-activated elastomers, which may operate based on absorption and dissolution, may be affected by fluid temperature as well as the concentration and specific gravity of hydrocarbons in a fluid. A water-activated elastomer may be affected by water temperature and/or salinity. A water-activated elastomer may operate at least in part via osmosis. A water-activate elastomer may operate based on a chemical reaction, which may be irreversible. In such an approach, when water is absorbed, reactive fillers expand and stiffen, building a secondary network within the elastomer as it swells. This network can mechanically reinforce the elastomer and enables higher differential pressures to be withstood by shorter lengths. It may also minimize thermal contraction.

A swellable composition can include inorganic material dispersed within a polymer matrix, where the inorganic material swells on contact with water due to hydration and phase modification of the inorganic material. A mineral filler capable of swelling on contact with water may be utilized (consider a metal oxide such as one or more of magnesium oxide (MgO) or calcium oxide (CaO)). A polymer may be a thermoset material, a thermoplastic material, etc.; consider a polymer matrix that includes one or more of polyetheretherketone, polyaryletherketones, polyamides (Nylon 6, Nylon 6, 6, Nylon 6, 12, Nylon 6, 9, Nylon 12, Nylon 11), polycarbonate, polystyrene, polyphenylsulphone, polyphenylene sulphide, polysulphone, polytetrafluoroethylene, polypropylene, epoxy resins, furan resins, acrylonitrile-butadiene rubber, hydrogenated acrylonitrile-butadiene rubber and ethylene propylene diene M-class rubber (EPDM).

A polymer or polymers may be selected from one or more of polyetheretherketone, polyphenylsulphone, polyphenylene sulphide, polysulphone, polypropylene, acrylonitrile-butadiene rubber, hydrogenated acrylonitrile-butadiene rubber and ethylene propylenediene M-class (EPDM) rubber. EPDM may be utilized as a swellable material that can swell in response to exposure to hydrocarbon fluid.

A swellable material may be made by blending an absorbent polymer into an elastomer. In such an approach, the swellable material may be a swellable elastomer.

A swellable material may include one or more of nitrile butadiene rubber (NBR), styrene butadiene rubber (SBR) based compositions, chlorobutadiene rubber based compositions, silicon rubber based compositions, carboxymethylcellulose and clays, natural rubber based compositions, and butadiene rubber compositions.

A hydrocarbone oil-swellable elastomer may be a styrene butadiene rubber (SBR) (SBR with about 23.5% styrene, referenced as SBR 1502, marketed by Astlett Rubber, Inc., Oakville, Ontario, Canada).

An oil-swellable material can swell when in contact with oil and may include one or more of neoprene rubber, natural rubber, nitrite rubber, hydrogenated nitrite rubber, acrylate butadiene rubber, poly acrylate rubber, butyl rubber, brominated butyl rubber, chlorinated butyl rubber, chlorinated polyethylene, styrene butadiene copolymer rubber, sulphonated polyethylene, ethylene acrylate rubber, epichlorohydrin ethylene oxide copolymer, ethylene-propylene-copolymer (peroxide cross-linked), ethylene-propylene-copolymer (sulphur cross-linked), ethylene-propylene-diene terpolymer rubber, ethylene vinyl acetate copolymer, fluoro rubbers, fluoro silicone rubber, silicone rubber, styrene-butadiene elastomer, styrene-butadiene-styrene elastomer, acrylonitrile-styrene-butadiene elastomer, ethylene-propylene-diene elastomer, alkylstyrene, polynorbornene, resin such as precrosslinked substituted vinyl acrylate copolymers, polymers of styrenes and substituted styrenes, polyvinyl chloride, copolymers of vinyl chloride, polymers and copolymers of vinylidene, acrylic polymers such as polymers of methylmethacrylate, ethyl acrylate; polymers containing alternating units of at least two polymers selected from styrene, pentadiene, cyclopentadiene, butylene, ethylene, isoprene, butadiene and propylene; diatomaceous earth, and mixtures of one or more of such materials.

A silicone oil can be a liquid polymerized siloxane with organic side chains such as polydimethylsiloxane.

A swellable material can be a self-lubricating polymer that includes a cross-linked polymer (such as a rubber or elastomer) that is solvated with a liquid having a chemical affinity for that polymer material. In such an approach, chemical affinity can create a solvent effect that causes the polymer to absorb an amount of the liquid and swell. A cross-linked polymer may be capable of increasing its volume up to several folds by absorbing amounts of solvent. A swollen polymer network may be held together by molecular strands that are connected by chemical bonds (cross-links). Lubricating liquid may interact with a polymer due to intermolecular interactions such as solvation. To swell such a polymer, the enthalpy of mixing between the polymer and the lubricating liquid may be sufficiently low so that they mix readily with each other when mixed together, and/or undergo energetically favorable chemical interactions between each other.

Where a polymer is a hydrophobic polymer such as polydimethylsiloxane (PDMS), a lubricating liquid can be a hydrophobic liquid such as silicone oil, hydrocarbons, and/or the like; consider a silicone elastomer (covalently cross-linked) that can be swollen with a silicone oil. More particularly, consider a polydimethylsiloxane (PDMS) elastomer that can be swollen with silicone oil (methyl, hydroxyl, or hydride-terminated PDMS). Hydride-terminated PDMS may exhibit swelling with a range of lubricating liquids. Hydroxyl-terminated silicone oil in PDMS may be utilized as a type of swellable polymer providing an oleophobic/hydrophilic surface.

A seismic streamer can include an outer tube that defines an interior space; sensor packages disposed in the interior space; and spacers disposed in the interior space where the spacers include swellable material. A swellable material can be or include one or more of a hydrocarbon swellable material (a material that swells in the presence of hydrocarbon fluid, which can be a hydrocarbon oil and thus a hydrocarbon oil swellable material), a water swellable material (an aqueous fluid swellable material, etc.), a silicone oil swellable material, etc.

In a seismic streamer, spacers can define chambers within the interior space. A seismic streamer can include sensor packages that include hydrophone sensor packages and/or accelerometer sensor packages. One or more sensor packages may be disposed in a chamber defined by spacers in an interior space of a seismic streamer. A filler fluid can be disposed in the interior space of a seismic streamer and may be substantially compartmentalized by spacers.

Spacers can include through bores and through bore liners made of one or more types of swellable material. Spacers can include annular swellable material that swells to increase outer diameters of the spacers. An individual spacer can include an outer layer that is swellable that swells to increase the outer diameter of the spacer.

A spacer can include a base portion that is cylindrical and an annular portion that fits around the perimeter of the base portion. In such an approach, the annular portion can be made of a swellable material that can increase the outer diameter of the spacer. A base portion can include an annular groove that can seat the annular portion; consider an O-ring like annular portion that fits into a groove of a base portion. In such an approach, upon exposure to a fluid (a solvent), the annular portion can imbibe a portion of the fluid to increase in outer diameter and increase in sealing force against the base portion; consider a cross-sectional area of an annular portion that can increase such that the annular portion becomes thicker.

A seismic streamer can include a filler fluid disposed in an interior space defined at least in part by an outer tube (barrier layer, etc.). Spacers can include through bores and optionally through bore liners made of one or more swellable materials.

A method can include, in a seismic streamer that in an outer tube that defines an interior space, sensor packages disposed in the interior space and swellable material disposed in the interior space, exposing the swellable material to fluid; and, responsive to the exposing, swelling the swellable material. In such an approach, swelling of the swellable material can compartmentalize the interior space into compartments. Fluid can include silicone oil and/or one or more other types of fluid.

Exposing swellable material to fluid may occur in response to puncturing an outer tube of a seismic streamer (a barrier layer that acts to otherwise protect internals of the seismic streamer). Fluid can be or include seawater (water with one or more inorganic salts, etc.).

A method can include displacing an oil disposed in an interior space of a seismic streamer with the seawater, which may cause swelling of a swellable material or the seawater may be restricted to a compartment formed by one or more spacers that may include swollen material (previously swollen swellable material, etc.).

A method can include acquiring data from at least one sensor package of a seismic streamer prior to swelling of a swellable material in the seismic streamer and/or can include acquiring data from at least one sensor package of the seismic streamer after swelling of a swellable material in the seismic streamer. In such an approach, the swellable materials may differ.

A method can include, in a seismic streamer that includes an outer tube that defines an interior space, sensor packages disposed in the interior space and swellable material disposed in the interior space, exposing the swellable material to fluid; and, responsive to the exposing, swelling the swellable material. In such an approach, the swelling of the swellable material can compartmentalize the interior space into compartments. A method can include exposing swellable material to a fluid such as one or more of silicone oil and hydrocarbons (hydrocarbon oil, etc.).

Exposing swellable material may occur in response to puncturing an outer tube; consider a puncture allowing fluid to flow into an interior space where the fluid can be or include seawater.

A method can include acquiring data from at least one sensor package in a seismic streamer after swelling swellable material in the seismic streamer.

A swellable spacer for a seismic streamer can include an outer diameter less than approximately 80 millimeters; opposing axial faces that define an axial length less than approximately 15 centimeters; and at least one passage that extends between the opposing axial faces. In such a spacer, the passage may be utilized to receive a rope, a wire, a fiber, a housing, etc. Such swellable spacer can swell in response to contact with one or more types of fluids where the spacer, as swollen, acts to define, at least in part, a compartment in a seismic streamer. A compartment can be defined by a pair of swollen spacers.

A system may include instructions, circuitry, etc., which may be provided to analyze data, control a process, perform a task, perform a workstep, perform a workflow, etc.

A system may be a distributed environment such as a so-called “cloud” environment where various devices, components, etc. interact for purposes of data storage, communications, computing, etc. A device or a system may include one or more components for communication of information via one or more of the Internet (where communication occurs via one or more Internet protocols), a cellular network, a satellite network, etc. A method may be implemented in a distributed environment (wholly or in part as a cloud-based service).

A 3D printer may include one or more substances that can be output to construct a 3D object; consider printing material that can form at least part of a component that may be a streamer internal.

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words “means for” together with an associated function.

What is claimed is:

1. A seismic streamer comprising:
an outer tube that defines an interior space;
sensor packages disposed in the interior space; and
spacers disposed in the interior space wherein the spacers comprise swellable material.

2. The seismic streamer of claim 1 wherein the swellable material comprises a hydrocarbon swellable material.

3. The seismic streamer of claim 1 wherein the swellable material comprises a water swellable material.

4. The seismic streamer of claim 1 wherein the swellable material comprises an aqueous fluid swellable material.

5. The seismic streamer of claim 1 wherein the swellable material comprises a silicone oil swellable material.

6. The seismic streamer of claim 1 wherein the swellable material comprises a hydrocarbon oil swellable material.

7. The seismic streamer of claim 1 wherein the spacers define chambers within the interior space.

8. The seismic streamer of claim 1 wherein the sensor packages comprise hydrophone sensor packages.

9. The seismic streamer of claim 1 wherein the sensor packages comprise accelerometer sensor packages.

10. The seismic streamer of claim 1 comprising a filler fluid disposed in the interior space.

11. The seismic streamer of claim 1 wherein the spacers comprise spacers that comprise through bores and through bore liners made of the swellable material.

12. The seismic streamer of claim 1 wherein the spacers comprise spacers that comprise annular swellable material that swells to increase outer diameters of the spacers.

13. A method comprising:
in a seismic streamer that comprises an outer tube that defines an interior space, sensor packages disposed in the interior space and swellable material disposed in the interior space, exposing the swellable material to fluid; and
responsive to the exposing, swelling the swellable material.

14. The method of claim 13 wherein the swelling of the swellable material compartmentalizes the interior space into compartments.

15. The method of claim 13 wherein the fluid comprises silicone oil.

16. The method of claim 13 wherein the fluid comprises hydrocarbons.

17. The method of claim 13 wherein the exposing occurs in response to puncturing the outer tube.

18. The method of claim 17 wherein the fluid comprises seawater.

19. The method of claim 13 comprising acquiring data from at least one of the sensor packages after the swelling.

20. A swellable spacer for a seismic streamer, the swellable spacer comprising:
an outer diameter less than approximately 80 millimeters;
opposing axial faces that define an axial length less than approximately 15 centimeters; and
at least one passage that extends between the opposing axial faces.
